(19) United States
(12) Patent Application Publication
(10) Pub. No.: US 2016/0279555 A1
(43) Pub. Date: Sep. 29, 2016

(54) PARTICULATE MATERIAL CONTAINMENT SYSTEM AND METHOD

(71) Applicant: John Robert Anderson, Ishpeming, MI (US)

(72) Inventor: John Robert Anderson, Ishpeming, MI (US)

(21) Appl. No.: 15/079,190

(22) Filed: Mar. 24, 2016

Related U.S. Application Data
(60) Provisional application No. 62/137,402, filed on Mar. 24, 2015.

(51) Int. Cl. B01D 46/00

(52) U.S. Cl. CPC B01D 46/0012

(57) ABSTRACT

A system for safely disposing of fly/bottom ash from the process of burning coal within a landfill. The system effectively isolates ash from other wastes avoiding reactions, produces little or no leachate, thus reducing treatment costs. It can be operated regardless of weather, is better able to comply with future regulations. Encapsulating fly/bottom ash in bags is far safer, avoids treatment costs and the need for dust control.

### CROSS-REFERENCE TO RELATED APPLICATION

This application claims the benefit of priority of U.S. provisional application No. 62/137,402, filed Mar. 24, 2015, the contents of which are herein incorporated by reference.

### BACKGROUND OF THE INVENTION

The present invention relates to containment systems for landfills and, more particularly, to a containment systems for hazardous materials. Traditional methods of fly ash disposal expose fly/bottom ash to wind and weather increasing the risks to the environment. With current methods, fly ash is exposed to the elements and produces leachate. Current methods do not allow fly ash to be disposed of next to other landfill wastes. Ash needs its own special landfill. Mixing fly/bottom ash with landfill waste can cause dangerous chemical reactions, noxious fumes and leachate that is difficult to treat. Disposing of ash is difficult in windy weather and precipitation makes the process of tipping messy

Leachate from fly/bottom ash contains heavy metals and salts that are difficult and expensive to treat to comply with existing regulatory requirements . . . . Traditional methods expose fly/bottom ash to wind and weather increasing the risk to the environment. When mixed with Municipal Solid Waste (MSW) it can cause unwanted and deleterious reactions between waste materials. If ash is allowed to dry, it can become air borne and dispersed in the wind causing pollution and potential regulatory problems for the landfill operator. Leachate treatment and dust control are expensive. The same issues are present in an ash only landfill as well.

As can be seen, there is a need for a system and method that isolates ash from other wastes avoiding reactions, produces little or no leachate thus reducing treatment costs. Can be operated regardless of weather. Better able to comply with future regulations. Safer method for disposing of ash in a MSW or a dedicated ash landfill. Encapsulating fly/bottom ash in bags is far safer, avoids treatment costs and the need for dust control.

### SUMMARY OF THE INVENTION

In one aspect of the present invention, a containment system for particulate material, includes: a containment pit having a bottom and at least one sidewall; a liner disposed within the containment pit and covering the bottom and a substantial portion of the at least one sidewall; a containment vessel formed as an elongate flexible bag and adapted to be disposed within the pit, the containment vessel having an inlet adapted to receive a flow of particulate material and an outlet; a conveyor adapted to be coupled to a source of particulate material and configured to deliver the flow of particulate material to the containment vessel; and a filter operatively coupled to the outlet. In some embodiments, the at least one sidewall has a slope exceeding an angle of repose for the particulate waste. Preferably, the at least one sidewall has a slope of between about 35 to 40 degrees. Other embodiments of the system, include a drainage system, comprising a plurality of pipes disposed in the containment pit bottom above the liner. Preferably the plurality of pipes are perforated pipes and a porous layer of material may cover the plurality of pipes.

In some aspects of the system, the conveyor may be a pneumatic conveyor. In a preferred system, the elongate flexible bag has a generally rectangular cross section along its longitudinal axis. The containment vessel further include a plurality of containment vessels arranged in a row, wherein a subsequent containment vessel is disposed in abutment with a preceding containment vessel along a longitudinal length of the subsequent containment vessel and the preceding containment vessel. The plurality of containment vessels may also be disposed in a plurality of rows within the containment pit. The particulate material may be a fly ash.

In yet other aspects of the invention, a containment system for particulate material, includes a containment pit having a bottom and at least one sidewall; a containment vessel formed as an elongate flexible bag and adapted to be disposed within the pit, the containment vessel having an inlet adapted to receive a flow of the particulate material and an outlet; a conveyor adapted to be coupled to a source of particulate waste and configured to deliver the flow of particulate waste to the containment vessel; and a filter is operatively coupled to the outlet. The containment system may also have a liner disposed within the containment pit, the liner covering the bottom and a substantial portion of the at least one sidewall. The containment system can also be configured with a drainage system, having a plurality of interconnected pipes disposed in the containment pit bottom above the liner; and a porous layer of material covering the plurality of pipes. The containment system conveyor may be a pneumatic conveyor for carriage of dry particulate materials. In some embodiments, the elongate flexible bag has a generally rectangular cross section along its longitudinal axis. In certain aspects of the containment system, the containment vessel includes a plurality of containment vessels arranged in a row, wherein a subsequent containment vessel is disposed in abutment with a preceding containment vessel along a longitudinal length of the subsequent containment vessel and the preceding containment. The plurality of containment vessels may also be disposed in a plurality of rows within the containment pit.

A method according to other aspects of the invention includes: providing a containment pit having a bottom and at least one sidewall; providing a containment vessel formed as an elongate flexible bag and adapted to be disposed within the pit, the containment vessel having an inlet connected to receive a flow of particulate material and an outlet; providing a conveyor coupled to a source of particulate material and delivering the flow of particulate material to the containment vessel inlet; and providing a filter operatively coupled to the containment vessel outlet. The method of the present invention may also include: filling a plurality of containment vessels arranged in a row, wherein a subsequent containment vessel is disposed in abutment with a preceding containment vessel along a longitudinal length of the subsequent containment vessel and the preceding containment; and filling the plurality of containment vessels, wherein the containment vessels are disposed in a plurality of abutting rows within the containment pit.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is a perspective view of an embodiment of the present invention;

FIG. 3 is an sectional view of an embodiment taken along line 3-3 in FIG. 1;

FIG. 4 is a detail sectional view of an embodiment of the present invention.

FIG. 5 is a detail section view of the invention taken along line 5-5 in FIG. 2;

FIG. 6 is a top profile view of a containment vessel according to embodiments of the invention.

FIG. 7 is a flow chart for a method of particulate containment according to aspects of the invention.

FIG. 8 is a continuation of the flow chart of FIG. 7.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide a system, method, and apparatus for the encapsulation and containment of fly ash waste products. The system effectively contains and isolates fly ash thereby avoiding reactions with other waste products and produces little or no leachate thus reducing treatment costs. The system can be operated regardless of weather. Better able to comply with future regulations. It is a safer more effective method for disposing of ash in a Municipal Solid Waste (MSW) or a dedicated ash landfill. Encapsulating fly/bottom ash in bags is far safer, avoids treatment costs and the need for dust control.

As stated above, mixing fly/bottom ash with landfill waste can cause dangerous chemical reactions, producing noxious fumes and can also produce leachate that is difficult to treat or contain. With present methods, disposing of ash is difficult in windy weather and precipitation makes the process of tipping messy

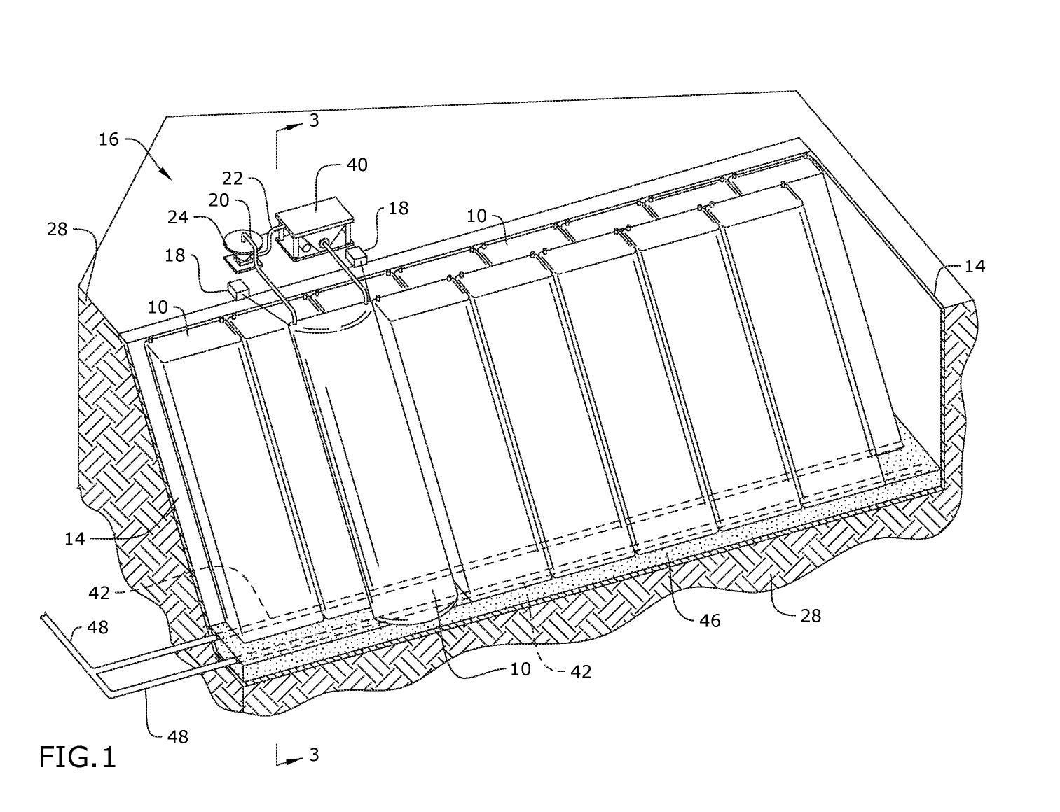

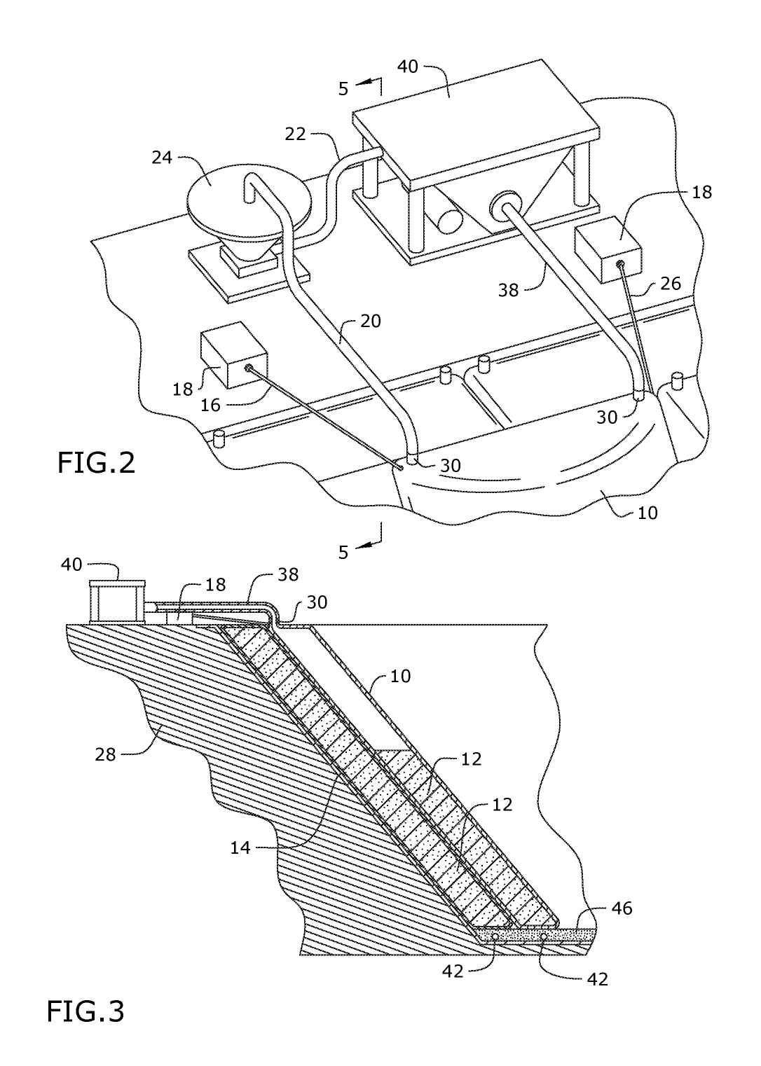

As seen in reference to FIGS. 1-5, a system according to embodiments of the present invention includes a depression, or pit which may be formed or excavated in an existing landfill or in the creation of a new landfill operation. The pit is formed with a sloped sidewall, preferably extending at a slope of between about 35 to 40 degrees and extending from a staging area 16. The size of the depression is selected to contain an expected volume of fly ash material therein. The opposite sidewall the depression may be formed with vertical or sloped side and the end walls may similarly be formed with vertical or sloped sides, preferably vertical.

A leachate liner is provided to cover the bottom and sidewalls of the depression. The leachate liner 14 is formed of any suitable material for the containment of leachate that may be produced by the fly ash, and is preferably formed of a high density polyethylene (HDPE) material. The leachate liner 14 should be made of a durable material and have a thickness of between about 40 and 60 mils. The bottom of the depression is configured with a leachate drainage system including one or more drainage pipes 42, which are preferably perforated pipes. The drainage pipes 42 are disposed within the depression so as to receive and communicate any leachate and other liquids, such as rain water, that may be collected within the depression and contained by the leachate liner 14. The drainage pipes may be covered with a suitable porous medium, such as gravel or sand to facilitate seepage and drainage into the drainage pipes 42. The drainage pipes 42 may be operatively connected to a conveyance pipe 44 to carry the leachate from the depression to a leachate retention pond where it may be treated.

Runoff collected in retention pond can be tested and discharged to watershed if it meets regulatory standards. Similarly, if contaminants are detected in the water collected in the retention pond requires treatment, the cause of the contamination can be located and sealed or cleaned up to keep discharge within regulatory limits.

The containment depression of the system provides redundancy in the event one or more of the containment vessels 10 should fail. The containment depression could work without these features, but without the backup liner/separate drainage a failed bag 10 could cause a difficult and expensive problem to repair and remediate.

The system of the present invention will also include a plurality of containment vessels 10, or bags, for holding a volume of the fly ash 12 therein. The containment vessels 10 are configured as elongate bags and are preferably formed to expand to a generally rectangular cylindrical cross section when filled with the fly ash 12. The cylindrical cross section may be defined in other shapes that permit efficient stacking and nesting of the bags 10 when filled with fly ash 12. The bags 10 will have a sealed bottom end, sidewalls and top end for containment of the fly ash 12 therein.

As seen in reference to FIG. 6, the bag 10 may be formed from a length of containment materials, such as HDPE, that may joined along its longitudinal length via a seam 34 and the end portions may also include a bottom seam 32 and a top seam 36, which seal the containment vessel 10. A top end of the containment vessel 10 is configured with an inlet 30 and an outlet 30, which may be alternatively utilized to receive fly ash 12 or vent the containment vessel 10, while the bag 10 is filled with fly ash 12. The bags 10 are preferably formed having a length of approximately 100′ and a width of approximately 25′.

As seen in reference to FIG. 1, the bags 10 are disposed within the depression along the sidewall adjacent to the staging area 16. One or more anchor lines 26 may be operatively attached between an anchor block 18 and a top end of the containment bag 10 to prevent the top end of the bag 10 from slipping into the depression. The bags 10 should be installed on a slope sufficient to allow the ash 12 to slide down inside the bag 10 and settle in the bottom.

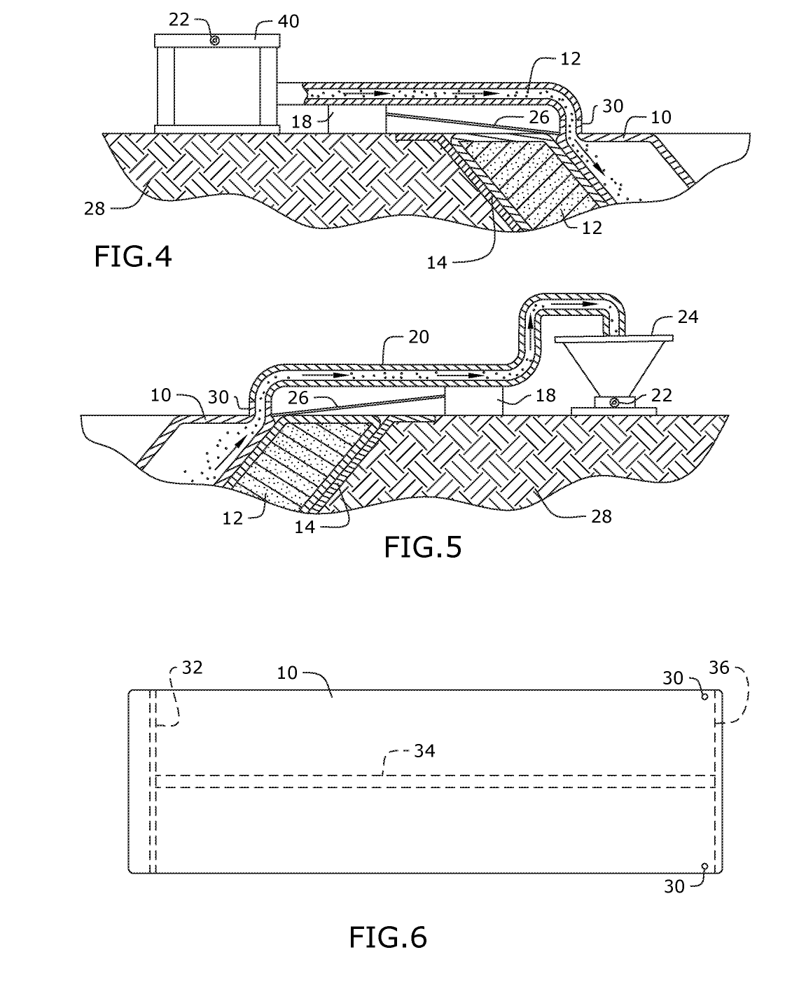

As seen in reference to FIG. 4, a conveyor 40 is operatively connected to the inlet 30 of the containment bag 10 via an ash delivery hose 38. The conveyor 40, may a vacuum, auger, or sealed conveyor system. For dry particulate matter, a preferred embodiment, a pneumatic conveyor 40 may be selected to maximize bag fill, and eliminate voids, thereby making the operation more efficient. As will be appreciated, certain situations may require the use of a different conveyor system.

The pneumatic conveyor is configured to communicate a quantity of fly ash 10 from a delivery source, such as a truck, rail car, or the like, or may even be configured to connect with a collection station at a fly ash producing facility. The pneumatic conveyor 40 is configured to deliver the fly ash 12 by entrainment of the particulates in an airflow. The airflow and fly ash 12 are delivered into the inlet 30 of the bag 10 wherein the fly ash 12 will fill the containment bag 10 from the bottom and fill the pneumatically expanded bag 10 as additional fly ash 12 is delivered. With the bag 10 held open and sloped beyond the angle of repose, the ash 12 will slide to the bottom of the bag 10 filling it and eliminating voids within the bag 10.

A filter system, such as an exhaust separator 24 is operatively coupled to the outlet 30 via an exhaust hose 20. The filter system 24 filters the vented delivery air of the pneumatic conveyor 40 as the fly ash 12 fills the containment bag 10, thereby eliminating any airborne displacement or discharge of the fly ash 12. The filtered fly ash material 12 may be delivered to the pneumatic conveyor 40 via a transfer hose 22. Pressure within the bag 10 may be regulated by a valve on the vent circuit, so that bag 10 will remain inflated and can be filled to maximum capacity.

Once a containment bag 10 has been filled to capacity, the delivery hose 38 and the vent hose 20 may be detached from the inlet 30 and outlet 30 and the openings 30 sealed thereby encapsulating the fly ash 12 within the containment bag 10. This sealing closure of the bag 10 prevents the contained fly ash 12 from being exposed to the elements and preventing a potential source for leachate formation. The containment of the fly ash 12 also provides a means of isolating the ash 12 from other landfill waste. Because the system is totally sealed ash can be disposed of regardless of weather conditions.

When a bag 10 is full, the conveyor 40 and filter 24 are attached to an adjacent bag 10 and the process is repeated. As the bags 10 in a first row are filled, a second row may be formed and the process continued until the depression is filled. As the subsequent bag fills it will conform to the shape of the first bag, thereby minimizing voids between bags 10. The second and subsequent rows of bags may be staggered so the so the bag 10 is centered between the adjoining faces of the bags of the previous row, in order to minimize voids. Once sufficient rows have been completed, washed sand may be pushed over the filled bags 10 and compacted. The staging area 16 may be moved out to fill bags 10 in the subsequent row.

The system of the present invention allows an option to building special landfills just for ash by using existing landfills. The system effectively isolates ash from other wastes avoiding reactions. Produces little or no leachate thus reducing treatment costs. These can be operated regardless of weather and are better able to comply with future regulations. Safer method for disposing of ash in a MSW or a dedicated ash landfill. Encapsulating fly/bottom ash in bags is far safer, avoids treatment costs and the need for dust control.

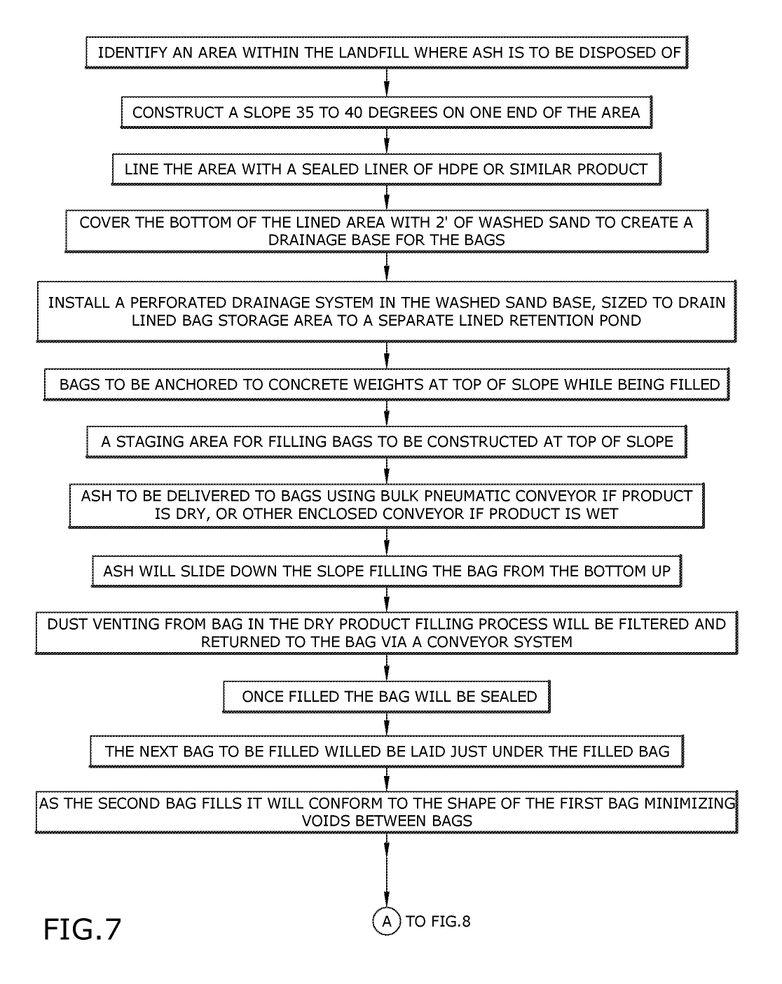

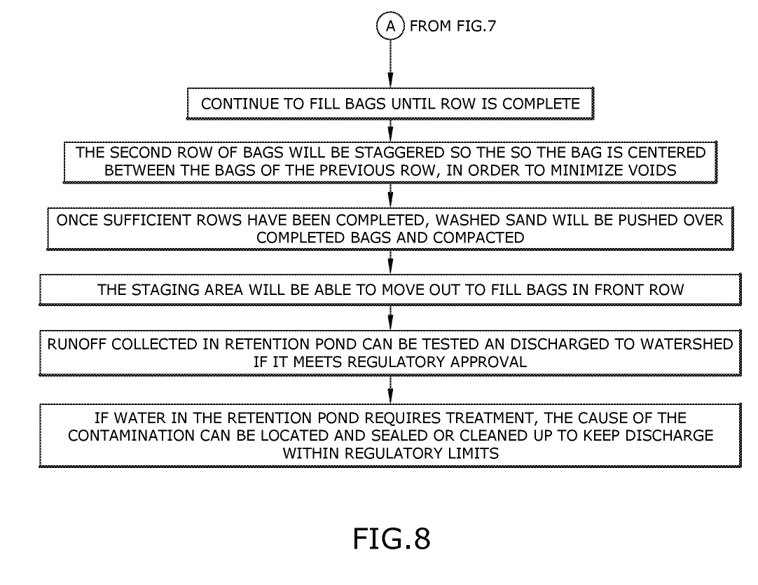

A method according to the present invention is provided in reference to FIGS. 7 and 8. The methods allow for the safe and efficient disposal of fly/bottom coal ash within a landfill cell that contains other solid waste. The methods could work equally well at a landfill dedicated to fly ash. Some or all of the method steps may be employed, depending upon the site requirements, materials contained and regulatory requirements pertinent to the same.

An area within a site for the ash needs to be built. Preferably the area will be provided with a 35-40 degree slope at one end. This area will preferably have a HDPE liner and drainage system adequate to handle precipitation anticipated at the site. This drainage system should have its own retention pond where water delivered to the pond can be tested and released if it meets regulations. The water may alternatively be treated and released without cross contamination from other landfill waste. This system prevents the ash from mixing with other waste and causing unwanted reactions should a bag fail.

Once the area is filled conventional water shedding may be installed, the cell should require little maintenance and minimal post closure costs. Conveying and filtering equipment may be installed on a trailer so that it can move as subsequent rows are constructed. The bags could be installed at a different slope or no slope at all. The slope and layout of bags should be selected to maximize space and save labor. Bags of various sizes and on different or no slope at all may work as intended, it would just be less efficient and may lead to more voids.

The systems and methods of the present invention used for disposing or storage of any product requiring encapsulation and isolation from the environment or the elements. It should be understood, of course, that the foregoing relates to exemplary embodiments of the invention and that modifications may be made without departing from the spirit and scope of the invention as set forth in the following claims.

What is claimed is:

1. A containment system for particulate material, comprising:
a containment pit having a bottom and at least one sidewall;
a liner disposed within the containment pit and covering the bottom and a substantial portion of the at least one sidewall;
a containment vessel formed as an elongate flexible bag and adapted to be disposed within the pit, the containment vessel having an inlet adapted to receive a flow of particulate material and an outlet;
a conveyor adapted to be coupled to a source of particulate material and configured to deliver the flow of particulate material to the containment vessel; and
a filter operatively coupled to the outlet.

2. The containment system of claim 1, wherein the at least one sidewall has a slope exceeding an angle of repose for the particulate waste.

3. The containment system of claim 1, wherein the at least one sidewall has a slope of between about 35 to 40 degrees.

4. The containment system of claim 1, further comprising:
a drainage system, comprising a plurality of pipes disposed in the containment pit bottom above the liner.

5. The containment system of claim 4, wherein the plurality of pipes are perforated pipes.

6. The containment system of claim 4, further comprising a porous layer of material covering the plurality of pipes.

7. The containment system of claim 1, wherein the conveyor is a pneumatic conveyor.

8. The containment system of claim 1, wherein the elongate flexible bag has a generally rectangular cross section along its longitudinal axis.

9. The containment system of claim 1, wherein the containment vessel further comprises a plurality of containment vessels arranged in a row, wherein a subsequent containment vessel is disposed in abutment with a preceding containment vessel along a longitudinal length of the subsequent containment vessel and the preceding containment vessel.

10. The containment system of claim 9, wherein the plurality of containment vessels are disposed in a plurality of rows within the containment pit.

11. The containment system of claim 10, wherein the particulate waste is a fly ash.

12. A containment system for particulate material, comprising:
a containment pit having a bottom and at least one sidewall;
a containment vessel formed as an elongate flexible bag and adapted to be disposed within the pit, the containment vessel having an inlet adapted to receive a flow of the particulate material and an outlet;
a conveyor adapted to be coupled to a source of particulate waste and configured to deliver the flow of particulate waste to the containment vessel; and
a filter operatively coupled to the outlet.

13. The containment system for claim 12, further comprising:
a liner disposed within the containment pit and covering the bottom and a substantial portion of the at least one sidewall;

14. The containment system of claim 13, further comprising:
a drainage system, comprising a plurality of interconnected pipes disposed in the containment pit bottom above the liner; and
a porous layer of material covering the plurality of pipes.

15. The containment system of claim 12, wherein the conveyor is a pneumatic conveyor.

16. The containment system of claim 12, wherein the elongate flexible bag has a generally rectangular cross section along its longitudinal axis.

17. The containment system of claim 12, wherein the containment vessel further comprises a plurality of containment vessels arranged in a row, wherein a subsequent containment vessel is disposed in abutment with a preceding containment vessel along a longitudinal length of the subsequent containment vessel and the preceding containment.

18. The containment system of claim 17, wherein the plurality of containment vessels are disposed in a plurality of rows within the containment pit.

19. A method of containing particulate material, comprising:
providing a containment pit having a bottom and at least one sidewall;
providing a containment vessel formed as an elongate flexible bag and adapted to be disposed within the pit, the containment vessel having an inlet adapted to receive a flow of particulate material and an outlet;
providing a conveyor adapted to be coupled to a source of particulate material and configured to deliver the flow of particulate material to the containment vessel inlet; and
providing a filter adapted to be operatively coupled to the containment vessel outlet.

20. The method of claim 19, further comprising:
filling a plurality of containment vessels arranged in a row, wherein a subsequent containment vessel is disposed in abutment with a preceding containment vessel along a longitudinal length of the subsequent containment vessel and the preceding containment; and
filling the plurality of containment vessels, wherein the containment vessels are disposed in a plurality of abutting rows within the containment pit.
